(19) United States
(12) Patent Application Publication
(10) Pub. No.: US 2010/0025122 A1
(43) Pub. Date: Feb. 4, 2010

(54) Image-Sensing Module and Image-Sensing System

(76) Inventors: Cho-Yi Lin, Hsinchu (TW); Chih-Hung Lu, Hsinchu (TW)

Correspondence Address: HDLS Patent & Trademark Services, P.O. BOX 220746, CHANTILLY, VA, 20153-0746, US

(21) Appl. No.: 12/252,468

(22) Filed: Oct. 16, 2008

(30) Foreign Application Priority Data
Aug. 4, 2008 (TW) 097129575

(51) Int. Cl. G06F 3/041; G06F 3/033

(52) U.S. Cl. 178/18.03; 178/19.01

(57) ABSTRACT

An image-sensing module includes an image-sensing chip and a processing unit. The image-sensing chip has a first image-sensing area and a second image-sensing area. The processing unit is electrically connected to the first image-sensing area and the second image-sensing area. In addition, the image-sensing system including the image-sensing module and a panel is also provided. The panel has a plane and a region located on the plane. The image-sensing module is disposed near the region. The image-sensing chip is disposed on the plane. The sensing range of the first image-sensing area covers the region. The sensing range of the second image-sensing area covers the region.

### BACKGROUND

1. Technical Field

The present invention relates to a sensing module and a sensing system, and in particular relates to an image-sensing module and an image-sensing system.

2. Description of the Related Art

Touch systems have been disclosed in many patents, such as U.S. Pat. No. 4,782,328 and U.S. Pat. No. 6,803,906. Each of the touch systems disclosed in the above two patents includes at least two sensors, and therefore the production cost of each of the touch systems disclosed in the above two patents is relatively high. One of the two patents is described thereinafter in detail.

FIG. 1 is a schematic view of a conventional touch screen system. Referring to FIG. 1, the touch screen system 100 disclosed in the U.S. Pat. No. 4,782,328 includes a panel 110, a first photosensor 120, a second photosensor 130 and a processor 140. The panel 110 includes a touch screen area 112 which is a rectangle. The first photosensor 120 and the second photosensor 130 are respectively disposed at two opposite ends of a boundary 112a of the touch screen area 112. The sensing range of the first photosensor 120 and that of the second photosensor 130 cover the touch screen area 112, respectively. In addition, the first photosensor 120 and the second photosensor 130 are electrically connected to the processor 140.

When a pointer 150 touches on the touch screen area 112, the first photosensor 120 senses the pointer 150 along a first sensing path 162 and the second photosensor 130 senses the pointer 150 along a second sensing path 164. According to the first sensing path 162 and the second sensing path 164, the processor 140 calculates the location of the pointer 150.

However, the touch screen system 100 must have two photosensors 120 and 130, and thus the production cost of the touch screen system 100 is relatively high.

### BRIEF SUMMARY

The present invention is directed to provide an image-sensing module which can be applied to an image-sensing system such that the production cost of the image-sensing system is reduced.

The present invention is directed to provide an image-sensing system of which the production cost is relatively low.

The image-sensing module of the present invention is provided. The image-sensing module includes an image-sensing chip and a processing unit. The image-sensing chip has a first image-sensing area and a second image-sensing area. The processing unit is electrically connected to the first image-sensing area and the second image-sensing area.

In an embodiment of the present invention, the image-sensing chip includes a substrate and an image-sensing array disposed on the substrate. The first image-sensing area is composed of a portion of the image-sensing array and the second image-sensing area is composed of another portion of image-sensing array. The processing unit is disposed on the substrate and located beside the image-sensing array.

In an embodiment of the present invention, the image-sensing chip includes a substrate, a first image-sensing array and a second image-sensing array. The first image-sensing array is disposed on the substrate and the first image-sensing area is composed of at least a portion of the first image-sensing array. The second image-sensing array is disposed on the substrate and located beside the first image-sensing array. The second image-sensing area is composed of at least a portion of the second image-sensing array. The processing unit is disposed on the substrate and located beside the first image-sensing array and the second image-sensing array.

In an embodiment of the present invention, the image-sensing module further includes a housing and a light-guiding element. The housing is disposed on the image-sensing chip and exposes the first image-sensing area and the second image-sensing area. The light-guiding element is disposed at the housing and corresponding to the first image-sensing area and the second image-sensing area.

In an embodiment of the present invention, the light-guiding element includes a first lens corresponding to the first image-sensing area and a second lens corresponding to the second image-sensing area.

In an embodiment of the present invention, the light-guiding element includes a first light-guiding portion corresponding to the first image-sensing area and a second light-guiding portion corresponding to the second image-sensing area. The first light-guiding portion includes a first plane-convex lens, a first triangular prism, a first medium prism, a second triangular prism and a second plane-convex lens. The first plane-convex lens and the first medium prism are disposed on two sides of the first triangular prism, respectively. The first medium prism and the second plane-convex lens are disposed on two sides of the second triangular prism, respectively. The second light-guiding portion includes a third plane-convex lens, a third triangular prism, a second medium prism, a fourth triangular prism and a fourth plane-convex lens. The third plane-convex lens and the second medium prism are disposed on two sides of the third triangular prism, respectively. The second medium prism and the fourth plane-convex lens are disposed on two sides of the fourth triangular prism, respectively.

The image-sensing system of the present invention is also provided. The image-sensing system is adapted to sensing a pointer and calculating a location of the pointer. The image-sensing system includes a panel and an image-sensing module. The panel has plane and a region located on the plane. The image-sensing module is disposed adjacent to the region. The image-sensing chip is disposed on the plane of the panel. The sensing range of the first image-sensing area covers the region and that of the second image-sensing area covers the region.

When the pointer approaches the region such that the pointer is located in the sensing range of the first image-sensing area and that of the second image-sensing area, the first image-sensing area and the second image-sensing area sense the pointer, respectively and the processing unit calculates the location of the pointer.

Because the image-sensing chip of the image-sensing module has the first image-sensing area and the second image-sensing area, the processing unit can calculate the location of the pointer. Accordingly, compared with the conventional arts, the image-sensing system of the embodiment of the present invention can use the image-sensing module having the image-sensing chip such that the production cost of the image-sensing system of the embodiment of the present invention is relatively low.

### BRIEF DESCRIPTION OF THE DRAWINGS

The accompanying drawings are included to provide a further understanding of the invention, and are incorporated in and constitute part of this specification. The drawings illustrate embodiments of the invention and, together with the description, serve to explain the principles of the invention.

FIG. 1 is a schematic view of a conventional touch screen system.

FIG. 2 is a schematic three-dimensional view of an image-sensing system in accordance with a first embodiment of the present invention.

FIG. 3 is a schematic cross-sectional view of an image-sensing module of FIG. 2.

FIG. 4 is a schematic side view of the image-sensing module of FIG. 2 disposed on a plane of a panel.

FIG. 5 is a schematic view showing that the processing unit of FIG. 3 calculates the location of the pointer.

FIG. 6 is a schematic side view of the image-sensing module of FIG.4 in the process of sensing.

FIG. 7 is a schematic cross-sectional view of an image-sensing module in accordance with a second embodiment of the present invention.

FIG. 8 is a schematic cross-sectional view of an image-sensing module in accordance with a third embodiment of the present invention.

FIG. 9 is a schematic side view of the image-sensing module of FIG. 8.

FIG. 10 is a schematic cross-sectional view of an image-sensing module in accordance with a fourth embodiment of the present invention.

FIG. 11 is a schematic cross-sectional view of an image-sensing module in accordance with a fifth embodiment of the present invention.

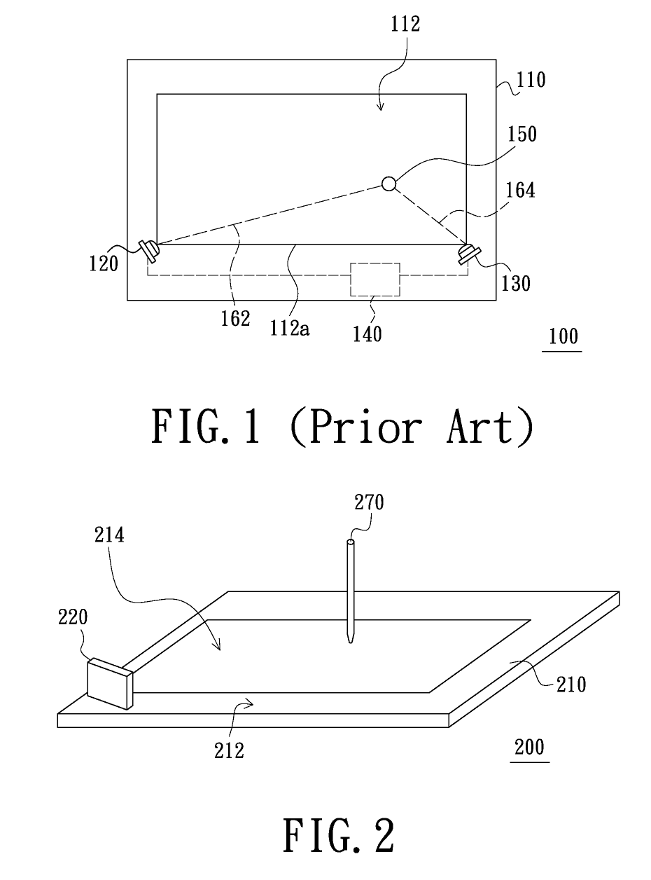

### DETAILED DESCRIPTION

Reference will now be made to the drawings to describe various exemplary embodiments of the present image-sensing modules and image-sensing systems in detail.

### First Embodiment

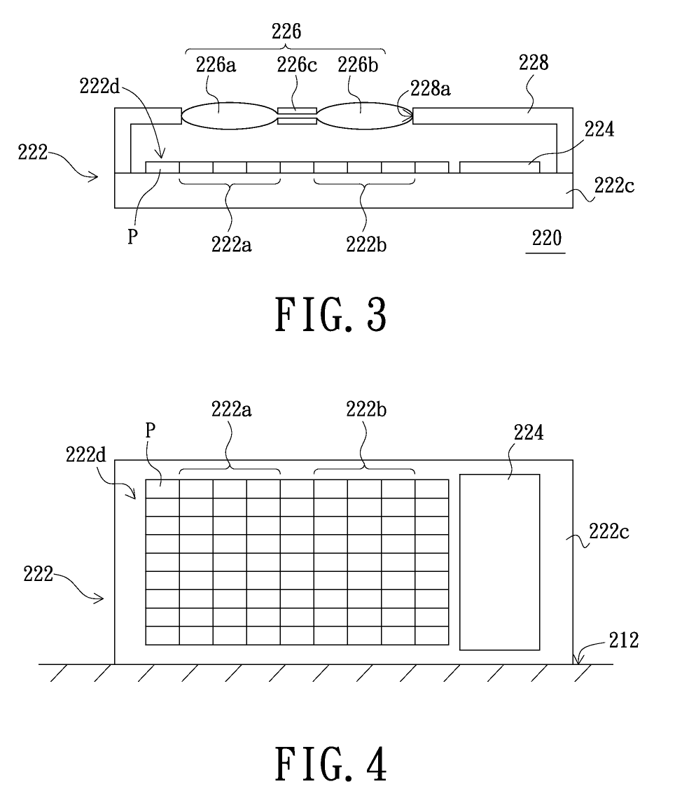

FIG. 2 is a schematic three-dimensional view of an image-sensing system in accordance with a first embodiment of the present invention. FIG. 3 is a schematic cross-sectional view of an image-sensing module of FIG. 2. FIG. 4 is a schematic side view of the image-sensing module of FIG. 2 disposed on a plane of a panel. It should be pointed out that some components are not shown in FIG. 4 for the convenience of description. Referring to FIGS. 2 to 4, the image-sensing system 200 is adapted to sensing a pointer 270 and calculating a location of the pointer 270 (please see the following detailed description). The image-sensing system 200 includes a panel 210 and an image-sensing module 220. The panel 210 may be a whiteboard or a touch screen. The panel 210 has a plane 212 and a region 214 located on the plane 212. The image-sensing module 220 is disposed adjacent to the region 214.

The image-sensing module 220 includes an image-sensing chip 222, a processing unit 224, a light-guiding element 226 and a housing 228. The image-sensing chip 222 is of complementary metal oxide semiconductor (CMOS) or of charge coupled device (CCD). The image-sensing chip 222 is disposed on the plane 212. The image-sensing chip 222 has a first image-sensing area 222a, a second image-sensing area 222b, a substrate 222c and an image-sensing array 222d. The substrate 222c may be composed of silicon. In addition, the sensing range of the first image-sensing area 222a covers the region 214 and that of the second image-sensing area 222b covers the region 214.

The image-sensing array 222d is disposed on the substrate 222c and has a plurality of pixels P. The first image-sensing area 222a is composed of a portion of the image-sensing array 222d and the second image-sensing area 222b is composed of another portion of image-sensing array 222d. In other words, the first image-sensing area 222a is composed of a portion of the pixels P and the second image-sensing area 222b is composed of another portion of the pixels P. In this embodiment, the shape of the first image-sensing area 222a and that of the second image-sensing area 222b are the same and the size of the first image-sensing area 222a and that of the second image-sensing area 222b are the same. This embodiment is described as an example only and is not intended to limit the scope of the present invention.

The housing 228 is disposed on the image-sensing chip 222 and exposes the first image-sensing area 222a and the second image-sensing area 222b. The light-guiding element 226 is disposed at the housing 228 and corresponding to the first image-sensing area 222a and the second image-sensing area 222b. In this embodiment, the housing 228 is disposed on the substrate 222c of the image-sensing chip 222 and has an opening 228a. The opening 228a is corresponding to the first image-sensing area 222a and the second image-sensing area 222b and the light-guiding element 226 is disposed at the opening 228a. In this embodiment, the light-guiding element 226 includes a first lens 226a (such as a biconvex lens), a second lens 226b (such as a biconvex lens) and a light-shading element 226c. The first lens 226a and the second lens 226b are integrally formed. The light-shading element 226c is disposed at the connection between the first lens 226a and the second lens 226b. The first lens 226a and the second lens 226b are corresponding to the first image-sensing area 222a and the second image-sensing area 222b, respectively. In this embodiment, the center of the first lens 226a is aligned with the center of the first image-sensing area 222a and the center of the second lens 226b is aligned with the center of the second image-sensing area 222b.

It should be pointed that, in another embodiment, the first lens 226a may be a plane-convex lens and the second lens 226b may be a plane-convex lens but they are not shown in any drawings. In addition, in another embodiment, the housing may have two opening 228a and the first lens and the second lens are disposed at the openings 228a, respectively but they are not shown in any drawings. In other words, the outline of the light-guiding element 226 and the number of the openings 228a of the housing 228 can be configured according to a designer's requirement. The present invention is not limited herein.

The processing unit 224 is electrically connected to the first image-sensing area 222a and the second image-sensing area 222b. The processing unit 224 is disposed on the substrate 222c and located beside the image-sensing array 222d. The processing unit 224 is located in the housing 228.

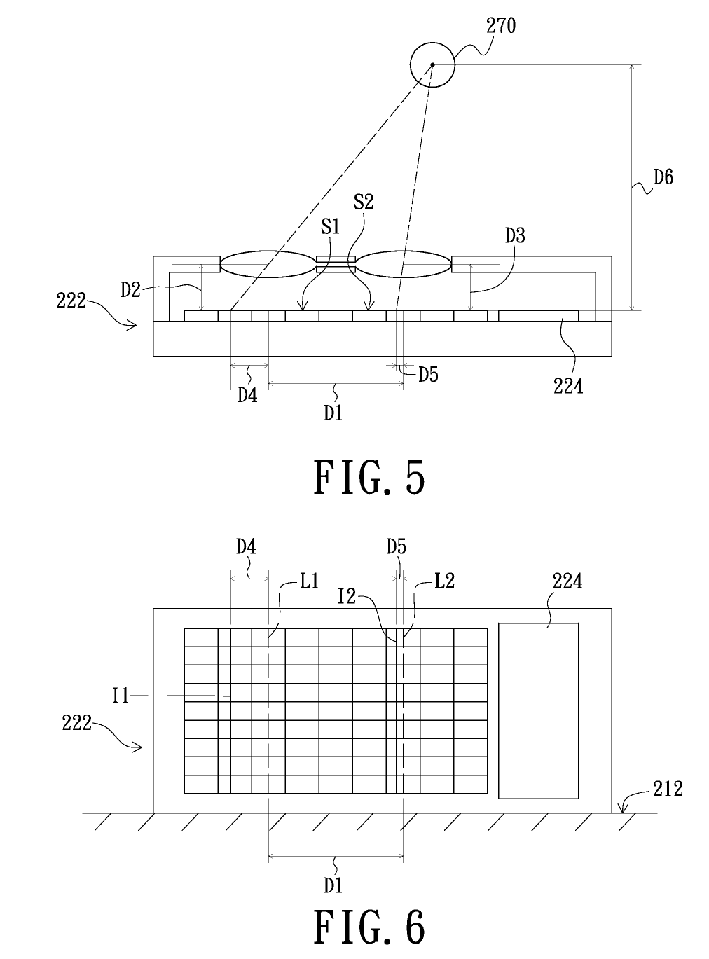

The operation of the image-sensing system 200 is described as follows. FIG. 5 is a schematic view showing that the processing unit of FIG. 3 calculates the location of the pointer. FIG. 6 is a schematic side view of the image-sensing module of FIG. 4 in the process of sensing. Referring FIGS. 2 to 6, when the pointer 270 approaches the region 214 such that the pointer 270 is located in the sensing range of the first image-sensing area 222a and that of the second image-sensing area 222b, the first image-sensing area 222a and the second image-sensing area 222b sense the pointer 270, respectively and the processing unit 224 calculates the location of the pointer 270.

In specific, a first distance D1 is between a centerline L1 of the first image-sensing area 222a has and a centerline L2 of the second image-sensing area 222b. In this embodiment, the centerlines L1, L2 are both perpendicular to the plane 212. In addition, a sensing surface S1 of the first image-sensing area 222a is located at a focus of the first lens 226a and that is, a second distance D2 between the sensing surface S1 and the center of the first lens 226a is equal to a focal length of the first lens 226a. A sensing surface S2 of the second image-sensing area 222b is located at a focus of the second lens 226b and that is, a third distance D3 between the sensing surface S2 and the center of the second lens 226b is equal to a focal length of the second lens 226b. In this embodiment, the second distance D2 is equal to the third distance D3 and that is, the sensing surface S1 and the sensing surface S2 are coplanar.

The information about the first distance D1 and the second distance D2 are built in the processing unit 224. When the pixels P in the same column of the first image-sensing area 222a sense the pointer 270 such that a first image I1 is formed and the pixels P in the same column of the second image-sensing area 222b sense the pointer 270 such that a second image I2 is formed, the processing unit 224 may calculate a fourth distance D4 between the centerline L1 and the first image I1 and a fifth distance D5 between the centerline L2 and the second image I2. Accordingly, a sixth distance D6 between the pointer 270 and the sensing surface S1 can be determined by means of a mathematical relation built in the processing unit 224. The mathematical relation is that an absolute value of the difference between the fourth distance D4 and the fifth distance D5 is equal to a value calculated by means of dividing the product of the first distance D1 and the second distance D2 by the sixth distance D6. The mathematical formula for the mathematical relation is |D4−D5|(D1×D2)/D6.

Because the image-sensing chip 222 of the image-sensing module 220 has the first image-sensing area 222a and the second image-sensing area 222b, the processing unit 224 can calculate the location of the pointer 270. Accordingly, compared with the conventional arts, the image-sensing system 200 of the present embodiment can use the image-sensing module having the image-sensing chip 222 such that the production cost of the image-sensing system 200 of the embodiment is relatively low.

### Second Embodiment

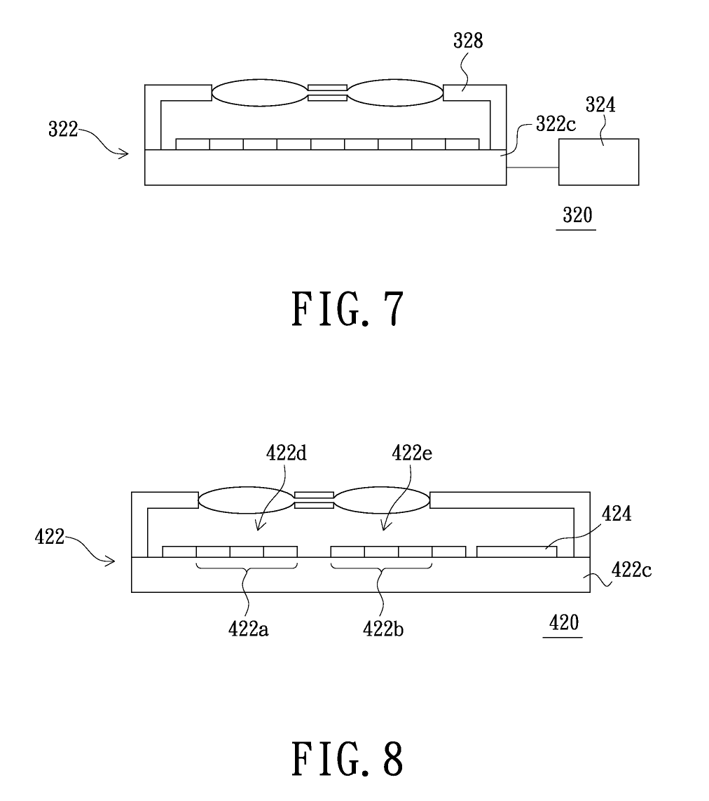

FIG. 7 is schematic cross-sectional view of an image-sensing module in accordance with a second embodiment of the present invention. Referring to FIG. 7, the difference between the image-sensing module 320 of the second embodiment and the image-sensing module 220 of the first embodiment lies in that a processing unit 324 of the second embodiment is not disposed on a substrate 322c of an image-sensing chip 322. In other words, the processing unit 324 is disposed outside a housing 328.

### Third Embodiment

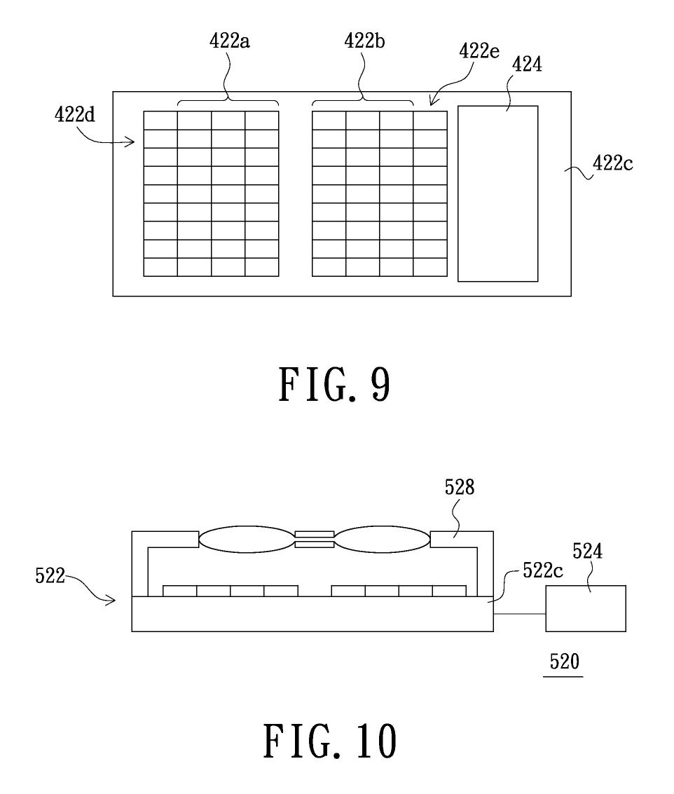

FIG. 8 is a schematic cross-sectional view of an image-sensing module in accordance with a third embodiment of the present invention. FIG. 9 is a schematic side view of the image-sensing module of FIG. 8. It should be pointed out that some components are not shown in FIG. 9 for the convenience of description. Referring to FIGS. 8 and 9, the difference between the image-sensing module 420 of the third embodiment and the image-sensing module 220 of the first embodiment lies in that an image-sensing chip 422 of the image-sensing module 420 of the third embodiment further includes a first image-sensing array 422d and a second image-sensing array 422e. The first image-sensing array 422d is disposed on a substrate 422c. A first image-sensing area 422a is composed of at least a portion of the first image-sensing array 422d. The second image-sensing array 422e is disposed on a substrate 422c and located beside the first image-sensing array 422d. A second image-sensing area 422b is composed of at least a portion of the second image-sensing array 422e. A processing unit 424 is disposed on the substrate 422c and located beside the first image-sensing array 422d and the second image-sensing array 422e.

### Fourth Embodiment

FIG. 10 is a schematic cross-sectional view of an image-sensing module in accordance with a fourth embodiment of the present invention. Referring to FIG. 10, the difference between the image-sensing module 520 of the fourth embodiment and the image-sensing module 420 of the third embodiment lies in that a processing unit 524 of the fourth embodiment is not disposed on a substrate 522c of an image-sensing chip 522. In other words, the processing unit 524 is disposed outside a housing 528.

### Fifth Embodiment

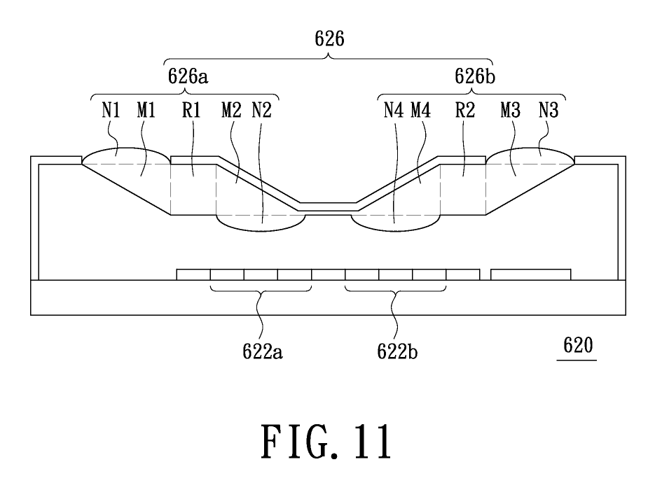

FIG. 11 is a schematic cross-sectional view of an image-sensing module in accordance with a fifth embodiment of the present invention. Referring to FIG. 11, the difference between the image-sensing module 620 of the fifth embodiment and the image-sensing module 220 of the first embodiment lies in that a light-guiding element 626 of the fifth embodiment includes a first light-guiding portion 626a and a second light-guiding portion 626b. The first light-guiding portion 626a is corresponding to a first image-sensing area 622a and the second light-guiding portion 626b is corresponding to the second image-sensing area 622b. The first light-guiding portion 626a includes a first plane-convex lens N1, a first triangular prism M1 (such as a right-angled triangular prism), a first medium prism R1 (such as a rectangular prism), a second triangular prism M2 (such as a right-angled triangular prism) and a second plane-convex lens N2. The first plane-convex lens N1 and the first medium prism R1 are disposed on two sides of the first triangular prism M1, respectively. The first medium prism R1 and the second plane-convex lens N2 are disposed on two sides of the second triangular prism M2, respectively. In addition, the second plane-convex lens N2 and the second triangular prism M2 are located over the first image-sensing area 622a.

The second light-guiding portion 626b includes a third plane-convex lens N3, a third triangular prism M3 (such as a right-angled triangular prism), a second medium prism R2 (such as a rectangular prism), a fourth triangular prism M4 (such as a right-angled triangular prism) and a fourth plane-convex lens N4. The third plane-convex lens N3 and the second medium prism R2 are disposed on two sides of the third triangular prism M3, respectively. The second medium prism R2 and the fourth plane-convex lens N4 are disposed on two sides of the fourth triangular prism M4, respectively. In addition, the fourth plane-convex lens N4 and the fourth triangular prism M4 are located over the second image-sensing area 622b. In this embodiment, the first light-guiding portion 626a and the second light-guiding portion 626b are symmetrical and integrally formed. In alternative embodiments, the first light-guiding portion 626a and the second light-guiding portion 626b can be formed separately.

As mentioned above, the image-sensing module and the image-sensing system of the present embodiment of the present invention at least has one of the following advantages or other advantages. Because the image-sensing chip of the image-sensing module has the first image-sensing area and the second image-sensing area, the processing unit can calculate the location of the pointer. Accordingly, compared with the conventional arts, the image-sensing system of the embodiment of the present invention can use the image-sensing module having the image-sensing chip such that the production cost of the image-sensing system of the embodiment of the present invention is relatively low.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An image-sensing system adapted to sensing a pointer and calculating a location of the pointer, comprising:
a panel having a plane and a region located on the plane; and
an image-sensing module disposed adjacent to the region, comprising:
an image-sensing chip disposed on the plane, the image-sensing chip having a first image-sensing area and a second image-sensing area, the sensing range of the first image-sensing area covering the region and the sensing range of the second image-sensing area covering the region; and
a processing unit electrically connected to the first image-sensing area and the second image-sensing area;
wherein when the pointer approaches the region such that the pointer is located in the sensing range of the first image-sensing area and the sensing range of the second image-sensing area, the first image-sensing area and the second image-sensing area sense the pointer, respectively and the processing unit calculates the location of the pointer.

2. The image-sensing system according to claim 1, wherein the image-sensing chip comprises a substrate and an image-sensing array disposed on the substrate, the first image-sensing area is composed of a portion of the image-sensing array, and the second image-sensing area is composed of another portion of image-sensing array.

3. The image-sensing system according to claim 2, wherein the processing unit is disposed on the substrate and located beside the image-sensing array.

4. The image-sensing system according to claim 1, wherein the image-sensing chip comprises a substrate, a first image-sensing array and a second image-sensing array, the first image-sensing array is disposed on the substrate, the first image-sensing area is composed of at least a portion of the first image-sensing array, the second image-sensing array is disposed on the substrate and located beside the first image-sensing array, and the second image-sensing area is composed of at least a portion of the second image-sensing array.

5. The image-sensing system according to claim 4, wherein the processing unit is disposed on the substrate and located beside the first image-sensing array and the second image-sensing array.

6. The image-sensing system according to claim 1, wherein the image-sensing module further comprises a housing and a light-guiding element, the housing is disposed on the image-sensing chip and exposes the first image-sensing area and the second image-sensing area, and the light-guiding element is disposed at the housing and corresponding to the first image-sensing area and the second image-sensing area.

7. The image-sensing system according to claim 6, wherein the light-guiding element comprises a first lens corresponding to the first image-sensing area and a second lens corresponding to the second image-sensing area.

8. The image-sensing system according to claim 6, wherein the light-guiding element comprises a first light-guiding portion corresponding to the first image-sensing area and a second light-guiding portion corresponding to the second image-sensing area, the first light-guiding portion includes a first plane-convex lens, a first triangular prism, a first medium prism, a second triangular prism and a second plane-convex lens, the first plane-convex lens and the first medium prism are disposed on two sides of the first triangular prism, respectively, the first medium prism and the second plane-convex lens are disposed on two sides of the second triangular prism, respectively, the second light-guiding portion includes a third plane-convex lens, a third triangular prism, a second medium prism, a fourth triangular prism and a fourth plane-convex lens, the third plane-convex lens and the second medium prism are disposed on two sides of the third triangular prism, respectively, and the second medium prism and the fourth plane-convex lens are disposed on two sides of the fourth triangular prism, respectively.

9. An image-sensing module comprising:
an image-sensing chip having a first image-sensing area and a second image-sensing area; and
a processing unit electrically connected to the first image-sensing area and the second image-sensing area.

10. The image-sensing module according to claim 9, wherein the image-sensing chip comprises a substrate and an image-sensing array disposed on the substrate, the first image-sensing area is composed of a portion of the image-sensing array, and the second image-sensing area is composed of another portion of image-sensing array.

11. The image-sensing module according to claim 10, wherein the processing unit is disposed on the substrate and located beside the image-sensing array.

12. The image-sensing module according to claim 9, wherein the image-sensing chip comprises a substrate, a first image-sensing array and a second image-sensing array, the first image-sensing array is disposed on the substrate, the first image-sensing area is composed of at least a portion of the first image-sensing array, the second image-sensing array is disposed on the substrate and located beside the first image-sensing array, and the second image-sensing area is composed of at least a portion of the second image-sensing array.

13. The image-sensing module according to claim 12, wherein the processing unit is disposed on the substrate and located beside the first image-sensing array and the second image-sensing array.

14. The image-sensing module according to claim 9, further comprising a housing and a light-guiding element, wherein the housing is disposed on the image-sensing chip and exposes the first image-sensing area and the second image-sensing area, and the light-guiding element is disposed at the housing and corresponding to the first image-sensing area and the second image-sensing area.

15. The image-sensing module according to claim 14, wherein the light-guiding element comprises a first lens corresponding to the first image-sensing area and a second lens corresponding to the second image-sensing area.

16. The image-sensing module according to claim 14, wherein the light-guiding element comprises a first light-guiding portion corresponding to the first image-sensing area and a second light-guiding portion corresponding to the second image-sensing area, the first light-guiding portion includes a first plane-convex lens, a first triangular prism, a first medium prism, a second triangular prism and a second plane-convex lens, the first plane-convex lens and the first medium prism are disposed on two sides of the first triangular prism, respectively, the first medium prism and the second plane-convex lens are disposed on two sides of the second triangular prism, respectively, the second light-guiding portion includes a third plane-convex lens, a third triangular prism, a second medium prism, a fourth triangular prism and a fourth plane-convex lens, the third plane-convex lens and the second medium prism are disposed on two sides of the third triangular prism, respectively, and the second medium prism and the fourth plane-convex lens are disposed on two sides of the fourth triangular prism, respectively.
